(19) United States
(12) Patent Application Publication
(10) Pub. No.: US 2003/0168260 A1
(43) Pub. Date: Sep. 11, 2003

(54) Weigh scale for an object, in particular a consumer product

(76) Inventor: Jacques Muyal, Gland (CH)

Correspondence Address: GREENBLUM & BERNSTEIN, P.L.C., 1950 ROLAND CLARKE PLACE, RESTON, VA, 20191, US

(21) Appl. No.: 10/276,308

(22) PCT Filed: May 22, 2001
(86) PCT No.: PCT/IB01/00895

(30) Foreign Application Priority Data
May 23, 2000 (CH) 1030/00

(51) Int. Cl. G01G 19/40

(52) U.S. Cl. 177/25.15

(57) ABSTRACT

The invention concerns a weigh scale (10) for a retail consumer product, in particular a food product, comprising a weighing member (11), a computing unit (12) and two display units (13, 14). The weighing member (11) is a standard self-activated member comprising a base (15) and a weigh plate (16). The computing unit (12) is a standard computer integral with a support (18) and coupled to the weighing member (11). Said computer comprises a calculating software designed to calculate the prices of the products weighed by the weighing member and function keys (19). It is further equipped with a magnetic tape reader (20) and an optical compact disc reader (21) designed to display simultaneously efficient and attractive advertising means aimed at a buyer. The display unit (13) is designed for a seller while the display unit (14) provided with sound reproduction means (22) is oriented towards the buyer to enable, besides display of characteristics of the purchased products, commercial spots.

### TECHNICAL DOMAIN

The present invention concerns a scale for weighing an object, particularly a consumer food product, in particular a food product sold on retail stores by a vendor to a client, this scale having a weighing unit, at least a first and a second display unit designed to display data relating to the nature, the weight and the price of the purchased object, respectively oriented towards the vendor and the client, at least a computing unit to determine the price of this object relating to its weight and a printing unit of a label including the data corresponding to the nature, the weight and the price of the object.

### PRIOR ART

It is already known weighing scales utilised for the sale of food products as meat, meat products, cheese, fish and other products like fruits and vegetables in retail stores that carry these different components. The display is provided by means of a large screen oriented towards the vendor and showing all necessary data which he needs, such as the nature of the product to sell, its weight, its price, and so on and by a second display oriented towards the client which displays the essential data for him, i.e. weight and cost.

On some scales, this second display is designed to show also a text scrolling advertising message, for example an alphanumeric message concerning a promotion campaign inside the store.

The purpose of this display is to bring up the attention of the client on products that are on promotion, particularly when the customer is automatically checking and for sure concentrating in reading the display showing the weight and cost of the product he is buying.

The scale disclosed by the publication JP 032125 includes a double display screen client/vendor for displaying messages or advertising images when the screen is not used for weighing operations. With such a scale, it is not possible to have simultaneous display of clips and of data related to the weighted product.

It is also known by the publication DE 35 18 119 a scale with a price computing function which allows also, when it is not in use, to display advertising information for the client stored in an additional memory.

It also exists devices such as the one described in the publication EP 0 443 419 which are designed to determine the prices of items of self service stores by means of a video camera linked to a memory comparing device which determines the price of the item by comparing the filmed item on shelve to a memorized image and which displays all information on a screen.

However, in all these devices the display remains relatively small and little readable, since it is buried in the mass of data that appears on the screen. The displayed message, whether it is static or dynamic, does not fulfill its mission which is to induce the client to buy or at least to attract his interest.

Further, the known weighing scales are complete instruments where all components are integrated and which electronic section is specific to each type of scale. The components of these scales consist essentially of a weighing device, a computing unit with its keyboard and display unit. The computing unit does not offer any other possibility than its elementary function of computing in order to display the price and the printing of a label. Each type of scale is specific and practically no main component is standard. As a fact, the manufacturing cost of such scales is high and any modification of functionality is only possible after a structural modification. Any improvement implies to conceive and produce a new product or a range of products of which the concept and productions are different from the previous ones.

These inconveniences of existing weighing scales make them not well suited to the retail trade as practiced today. On one side they are not suited to an advertising mission that would be given to them and, on the other side, they do not offer any flexibility and cannot be adapted on a permanent basis to the constant evolution needs of the market. Indeed, one of the dreams of advertising officers in the stores, and particularly in supermarkets, is to be able to present dynamic advertising on the point-of-sale. The big advertising screens located near the check-out cash registers in some supermarkets, theoretically responding to that need, are inefficient since the clients have finalised their purchase when they reach near the cash registers. In a supermarket, the only places where a client has to stop and wait in order to be served are the sections where he has to buy weighted items sold in front of public. These places are interested to display dynamic advertising.

### DESCRIPTION OF THE INVENTION

The object of the present invention is to solve all these above-mentioned inconveniences by offering a scale which allows, from its concept and its construction, to fulfill new functions matching needs of the market, by means of as much possible standard equipments which do not need fundamental constructive modifications to suit the evolution of market needs and which allows means of efficient and attractive advertising.

This aim is reached by a scale such as described in the preamble, characterized in that the said computing unit is integrated in a standard computer connected to the said weighing unit, the said computer comprising the said first display unit and being further coupled to the said second display unit.

According to a preferred embodiment, the said second display unit, which is oriented towards the client, is designed to allow further the broadcast of audiovisual advertising clips.

Preferably, the said first and the said second display units are two standard screens of the standard computer that integrates the said computing unit associated with the said weighing unit.

According to an advantageous embodiment, the said standard computer is equipped with specific softwares which allow the display of menus, called scrolling menus, on the said first display unit.

Preferably, the said standard computer is equipped with specific softwares that allow display animated advertising clips on the said second display unit.

For this, the said standard computer preferably comprises at least one reader of standard database corresponding to the advertising clips. This reader is advantageously a magnetic stripe reader or an optical reader of compact disks.

According to a particularly advantageous embodiment, the said standard computer can be connected to a network with a server designed to broadcast advertising clips on the said second display unit in a predetermined manner.

In view of a customised broadcast of advertising clips, the said standard computer can comprise a reader of client's personal card and means to broadcast an advertising clip selected from a data bank and related to characteristics corresponding to buying intentions identified by this personal card.

### SUMMARY OF THE DRAWINGS

The present invention and its advantages will better appear in the following description of a form of preferred embodiment of the described invention, as an example without limitation, with reference to enclosed drawings, in which:

FIG. 1 shows in a schematic way a first form of embodiment of the weighing scale according to the invention,

FIG. 2 represents a second form of q preferred embodiment of the weighing scale according to the invention, and

FIG. 3 represents, as an illustration, a view of the screen which constitutes the second display unit of the weighing scale according to the invention.

### PREFERRED EMBODIMENT(S) OF THE INVENTION

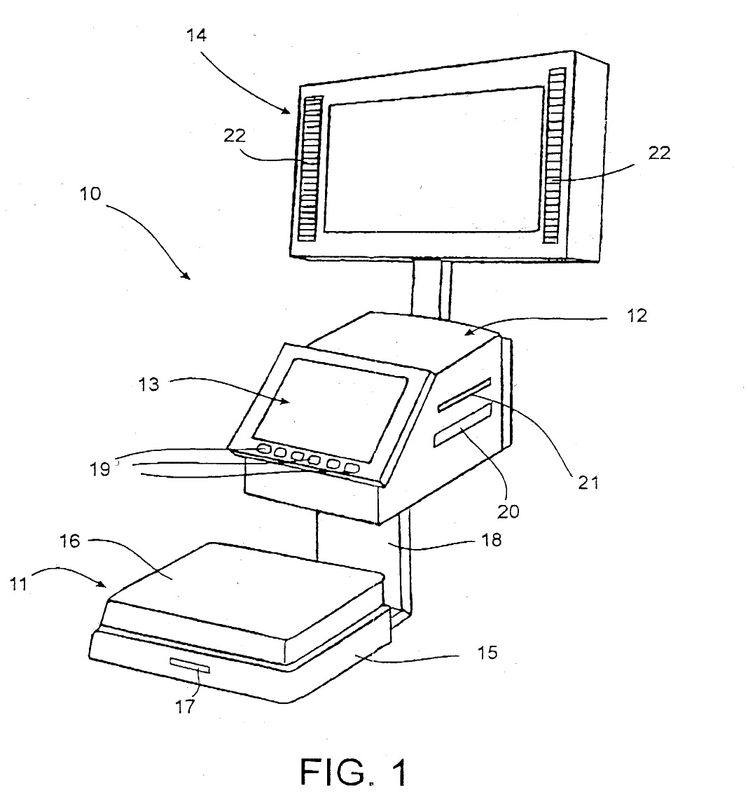

The weighing scale 10 of the invention, such as illustrated by FIG. 1, comprises principally a weighing unit 11, a standard computer 12 with its screen which is the said first display unit 13 and a second display unit 14. The weighing unit 11 consist of a self contained standard weighing cell, well known and not represented in details, located in a stand 15 in the form of a housing on which a weighing platform 16 is arranged. This housing also contains a printing module for labels/receipts (not shown) which delivers labels with the relative data of the nature of the product, its weight and its price through an output slot 17 provided in the stand 15.

The standard computer 12 is advantageously mounted on a support 18 and connected by cables passing inside the support to the weighing unit 11. This computer comprises, as well known per se, a computing software designed for computing the prices of products weighted by means of the weighing unit and function keys 19. The screen 13 of this computer is preferably a touch screen which allows to display all necessary indications for the functioning of the scale, for example by means of menus said “scrolling menus”. Further it is equipped of reading means of database, as for example a magnetic stripe reader 20 or an optical reader 21 for compact disks.

The second display unit 14 is preferably consisted of an liquid crystals screen or similar and a reproduction and broadcast device of sound messages, for example speakers 22 incorporated or installed on the side of the screen.

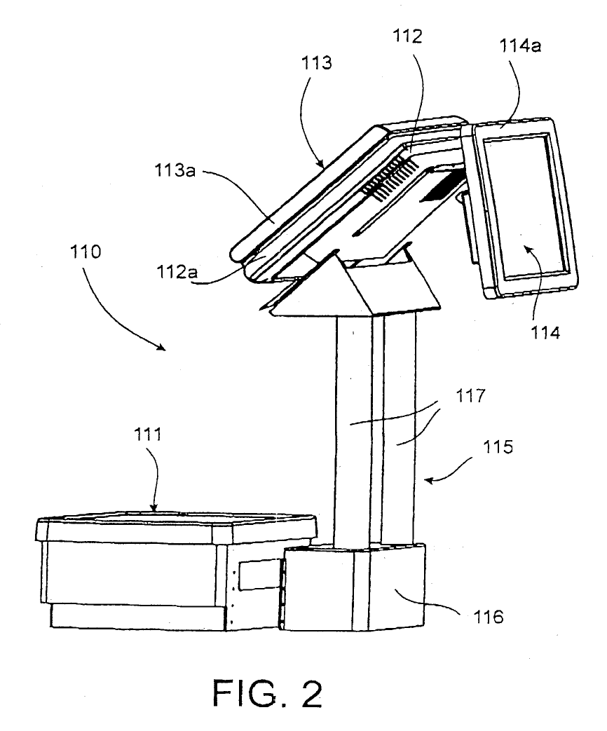

The FIG. 2 represents a preferred embodiment of the weighing scale 110 according to the invention. It comprises, as well as the weighing scale of FIG. 1, a weighing unit 111, a standard computer 112 associated to a first display unit 113 and to a second display unit 114. In this embodiment, the two display units are directly mounted on frames 113a and 114a moveable in respect to the housing 112a of the computer 112. They are advantageously flat, of liquid crystals type. The weighing module 111 is extended behind by a support consisting of a base 116 and two pipes 117 holding the computer 112 and the two display units 113 and 114. This very compact embodiment allows all expected functions. The computer is equipped with softwares that allow to handle simultaneously the management of two screens. It is installed in a network with a server that allows to broadcast advertising clips in an automatic, pre-programmed way or on demand, in a selective way. The clips can be downloaded or loaded by means of appropriate readers.

By the fact that the main component of the scale is a standard computer, this scale acquires all the intelligence of a computer and can evolve in relation with the evolution of softwares, which are loaded in the computer.

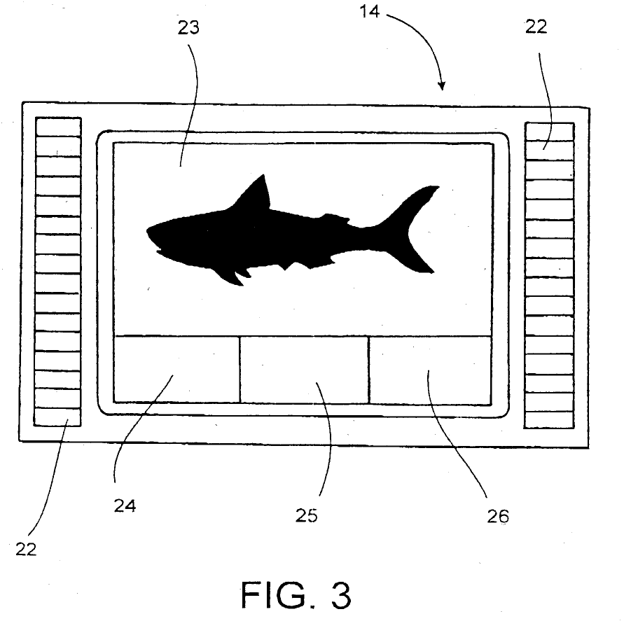

As shown with more details on FIG. 3, the screen forming the second display unit 14, oriented towards the client, comprises a central zone 23, preferably of relatively big size, which allows to display a static or animated advertising clip. Other display zones are prepared at the bottom or at the side, for example, a first zone 24 for displaying the nature of the purchased product, a second zone 25 to display the weight of the product and a third zone 26 to display its price. The speakers 22 can eventually broadcast a sound message simultaneously to the broadcast of the advertising clip on the screen.

The advertising clip is essentially for the client. The softwares contained in the computer drive selectively the displayed information. Therefore it can be arranged so that the messages are customized and different from one client to another. For this the computer is linked to a data bank which contains different advertising clips and that can be broadcasted selectively on demand. The demand is tailored to the client. It can be identified by means of a loyalty card that can recognize surely the buying intentions of the client by comparing with previous purchases.

In this manner one have not only a unique efficient way to display advertising directly on the point-of-sale, but one have a way allowing to match the advertising to each individual client in relation to its purchasing habits, therefore of his subjects of interest.

Since all the components of the weighing scale, i.e. the weighing unit, the computer and the second display unit are standard components, the cost of the ensemble is relatively low. Further, the fact of using of a real computer instead of a classic computing unit of a scale allows an infinity of additional functions and to benefit from an adaptable and flexible operation like never before.

1.—A scale for weighing an object, particularly a consumer food product, in particular a food product sold on retail stores by a vendor to a client, this scale having a weighing unit, at least a first and a second display unit designed to display data relating to the nature, the weight and the price of the purchased object, respectively oriented towards the vendor and the client, at least a computing unit to determine the price of this object relating to its weight and a printing unit of a label including the data corresponding to the nature, the weight and the price of the object, characterized in that the said computing unit is integrated into a standard computer (12,112) connected to the said weighing unit (11,111), the said computer comprising the said first display unit (13,113) and being further coupled to the said second display unit (14,114).

2.—A scale according to claim 1, characterized in that the said second display unit (14,114) which is oriented towards the client is designed to allow further the broadcast of audiovisual advertising clips.

3.—A scale according to claim 1, characterized in that the said first (13,113) and the said second display units (14,114) are two standard screens of the standard computer (12,112) which integrates the said computing unit associated with the weighing unit (11,111).

4.—A scale according to claim 1, characterized in that the said standard computer (12) is equipped with specific softwares which allow the display of menus, called scrolling menus on the said first display unit (13).

5.—A scale according to claim 1, characterized in that the said standard computer (12) is equipped with specific softwares which allow the display of animated advertising clips on the said second display unit (14).

6.—A scale according to claim 5, characterized in that the said standard computer (12) comprises at least one reader of a standard data base corresponding to the said advertising clips.

7.—A scale according to claim 6, characterized in that the said reader is a magnetic strip reader (20).

8.—A scale according to claim 6, characterized in that the said reader is an optical reader (21) of compact disks.

9.—A scale according to claim 1, characterized in that the said standard computer (12,112) is connected to a network with a server designed to broadcast advertising clips on the said second display unit (14,114) in a pre-determined manner.

10.—A scale according to claim 9, characterized in that the said standard computer (12,112) comprises a reader of client's personal card and means to broadcast an advertising clip selected from a data bank and adapted to characteristics corresponding to identified buying intentions on the basis of this personal card.
